(19) United States
(12) Patent Application Publication
(10) Pub. No.: US 2015/0032652 A1
(43) Pub. Date: Jan. 29, 2015

(54) SYSTEM AND PROCESS FOR INCREASING CONVERGENCE OF POTENTIAL DONORS TO ACTUAL DONORS OF PROJECTS SEEKING CROWDFUNDING

(71) Applicant: LISA BRANDES, Fort Bragg, CA (US)

(72) Inventor: LISA BRANDES, Fort Bragg, CA (US)

(21) Appl. No.: 14/340,431

(22) Filed: Jul. 24, 2014

Related U.S. Application Data
(60) Provisional application No. 61/858,465, filed on Jul. 25, 2013.

(51) Int. Cl. G06Q 30/02; G06Q 50/00

(52) U.S. Cl. CPC G06Q 30/0279; G06Q 50/01
USPC 705/319

(57) ABSTRACT

A system and process for increasing convergence of potential donors to actual donors of projects seeking crowdfunding is disclosed. In some embodiments, the system connects streaming video conversations, individual personal profiles, and fundable project descriptions to provide a potential project donor with a set of in-depth contextually relevant information resources related to a project seeking crowdfunding. In some embodiments, the process improves the conversion of potential project donors to actual project donors by presenting potential project donors with streaming video conversations, individual personal profiles of conversation participants, related fundable project descriptions, and related donation payment gateways which allows a potential project donor to become informed of the issues being addressed by a particular project seeking crowdfunding.

### CLAIM OF BENEFIT TO PRIOR APPLICATION

This application claims benefit to U.S. Provisional Patent Application 61/858,465, entitled “METHOD FOR CROWDFUNDING DONATIONS BY CONNECTING STREAMING VIDEO CONVERSATIONS, THOUGH LEADER PROFILES AND FUNDABLE PROJECTS,” filed Jul. 25, 2013. The U.S. Provisional Patent Application 61/858,465 is incorporated herein by reference.

### BACKGROUND

Embodiments of the invention described in this specification relate generally to project funding, and more particularly, to funding projects by crowdfunding.

Crowdfunding is a generic term for a method to fund new projects where individuals can visit a crowdfunding web site to view lists of projects and then make a direct monetary donation to projects of interest. Although many projects on crowdfunding websites involve broad social issues or have similarities to other projects with common issues, existing crowdfunding websites typically fail to provide any higher level context of the broad social issues and often do not connect projects that may be related to a common issue. Instead, most existing crowdfunding websites only list open crowdfunding projects and, for each project, only provide basic project information.

It is problematic finding more in-depth information and/or higher level discussions about a project that is seeking funding via crowdfunding. Many people who donate funds to crowdfunded projects find it challenging to choose between projects when all that is provided by the existing crowdfunding methods are simple lists of fundable projects. As a result, many potential project donors choose not to participate in crowdfunded projects or choose to contribute less money than they would otherwise choose to contribute if there was greater information depth, such as higher level discussion that provides a context around issues that fundable projects are addressing or social endorsements of projects by thought leaders who are experts in issues related to those projects.

Therefore, improvements to existing conventional crowdfunding methods and/or portals are desirable.

### BRIEF DESCRIPTION

Some embodiments of the invention include a novel system and process for increasing convergence of potential donors to actual donors of a project seeking crowdfunding.

In some embodiments, the system connects streaming video conversations, individual personal profiles, and fundable project descriptions to provide a potential project donor with a set of in-depth contextually relevant information resources related to a project seeking crowdfunding. In some embodiments, the system includes a user interface with a set of tools that allow a user of the system to input data to define (i) streaming video conversations, (ii) individual personal profiles of conversation participants, (iii) related fundable project descriptions, and (iv) related donation payment gateways. In some embodiments, the system stores the user input in a data structure that creates connections between all the related streaming video conversations, individual personal profiles of conversation participants, fundable project descriptions, and donation payment gateways. In some embodiments, the stored data is retrievable for display in a way that shows the connections between related streaming video conversations, individual personal profiles of conversation participants, fundable project descriptions, and donation payment gateways.

In some embodiments, the process improves the conversion of potential project donors to actual project donors by presenting potential project donors with streaming video conversations, individual personal profiles of conversation participants, related fundable project descriptions, and related donation payment gateways which allows a potential project donor to become informed of the issues being addressed by a particular project seeking crowdfunding. In some embodiments, the process performs separate sets of operations in two phases: a creation phase and a project access phase.

During the creation phase, the process receives input via a user interface which allows a user to define streaming video conversations, individual personal profiles of conversation participants, related fundable project descriptions, and related donation payment gateways. In some embodiments, the process stores the received input in a system storage as a data representation that creates connections between all the related streaming video conversations, individual personal profiles of conversation participants, fundable project descriptions, and donation payment gateways.

During the project access phase, the process retrieves the stored data and transmits the retrieved data for display on a computing display device of a user. The display of the transmitted data in some embodiments shows the connections between related streaming video conversations, individual personal profiles of conversation participants, fundable project descriptions, and donation payment gateways for a particular project.

In some embodiments, the process is implemented as a software application that runs on a computing device. In some embodiments, the software application is one of a website and a cloud service application. In some embodiments, potential project donors interact with a graphical user interface of the website or cloud service application. In some embodiments, potential project donors utilize client software to interact with the website or cloud service application. The client software can be any of a web browser application that runs on a processor of a computing device, a software application that runs on the processor of a client computer with access to the Internet, a mobile application that runs on the processor of a mobile computing device, and a mobile application that runs on the processor of a tablet computing device. The website user interface dynamically connects videos to related fundable projects and thought leader profiles.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a system that connects video conversations, personal profiles, and fundable project descriptions to provide a set of in-depth contextually relevant project information resources related to a project seeking crowdfunding in some embodiments.

FIG. 2 is a continuation of the system of FIG. 1.

FIG. 3 conceptually illustrates a process for providing in-depth contextually relevant project information related to a project seeking crowdfunding in some embodiments.

FIG. 4 is a continuation of the process of FIG. 3.

FIG. 5 conceptually illustrates an example of a website that implements the crowdfunding process in some embodiments.

FIG. 6 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

As stated above, many projects on crowdfunding websites involve broad social issues or have similarities to other projects with common issues, but existing crowdfunding websites do not provide higher level contextual information pertaining to the broad social issues of a project and often do not connect projects that may be related to a common issue. Instead, most existing crowdfunding websites only list open crowdfunding projects and, for each project, only provide basic project information. This is a problem for crowdfunded projects because many people who donate funds to crowdfunded projects find it challenging to choose between projects when all that is provided by the existing crowdfunding methods are simple lists of fundable projects. As a result, many potential project donors choose not to participate in crowdfunded projects or choose to contribute less money than they would otherwise choose to contribute if there was greater information depth, such as higher level discussion that provides a context around issues that fundable projects are addressing or social endorsements of projects by thought leaders who are experts in issues related to those projects.

Embodiments of the invention described in this specification solve such problems by facilitating funding of socially responsible projects in which streaming video of conversations between thought leaders on topics of social concern are presented via a user interface. Each video conversation is connected via navigable linkages to the individual profiles of the participating thought leaders as well as navigable linkages to the descriptions and donation interfaces for the list of projects that are relevant to the topic of each video conversation.

### I. Crowdfunding System

Some embodiments of the invention include a novel system that connects streaming video conversations, individual personal profiles, and fundable project descriptions to provide a potential project donor with a set of in-depth contextually relevant information resources related to a project seeking crowdfunding. In some embodiments, the system includes a user interface with a set of tools that allow a user of the system to input data to define (i) streaming video conversations, (ii) individual personal profiles of conversation participants, (iii) related fundable project descriptions, and (iv) related donation payment gateways. In some embodiments, the system stores the user input in a data structure that creates connections between all the related streaming video conversations, individual personal profiles of conversation participants, fundable project descriptions, and donation payment gateways. In some embodiments, the stored data is retrievable for display in a way that shows the connections between related streaming video conversations, individual personal profiles of conversation participants, fundable project descriptions, and donation payment gateways.

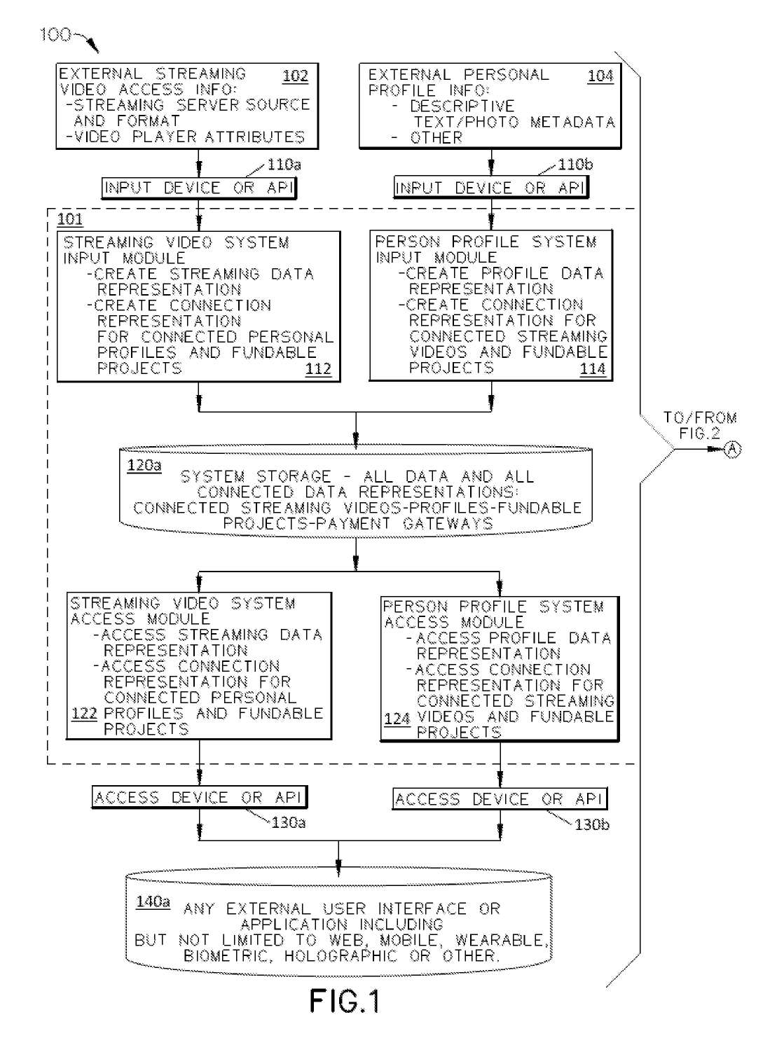

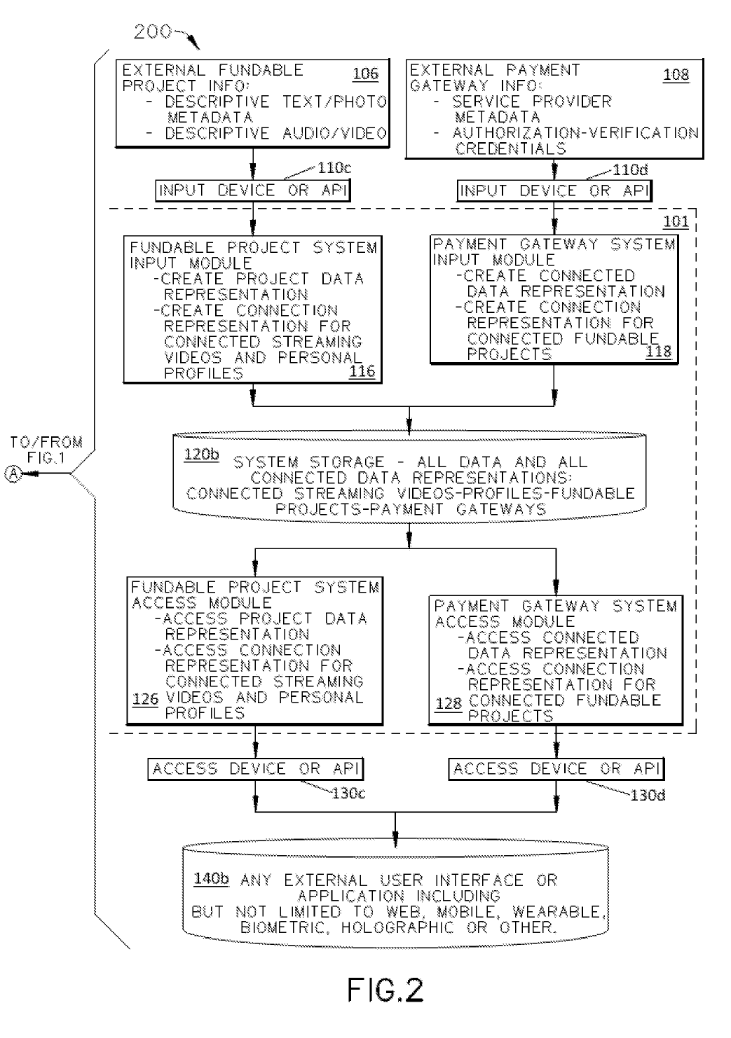

By way of example, FIGS. 1-2 conceptually illustrate schematic block diagrams 100 and 200 of a crowdfunding system 101 that connects video conversations, personal profiles, and fundable project descriptions to provide in-depth contextually relevant project information related to a project seeking crowdfunding. As shown in these figures, the crowdfunding system 101 includes a streaming video system input module 112, a person profile system input module 114, a fundable project system input module 116, a payment gateway system input module 118, a set of system storages 120a and 120b, a streaming video system access module 122, a person profile system access module 124, a fundable project system access module 126, and a payment gateway system access module 128.

The streaming video system input module 112 receives streaming server source and format data from a source that provides external streaming video access information 102 by way of an input device or API 110a. The streaming video system input module 112 may also receive sets of video player attributes from the source. For instance, a user may enter a URL for a streaming server source and its video format, as well as a set of video player attributes for optimized playback of the steamed video source in any of several hardware and/or software video media players. The streaming video system input module 112 then creates a streaming data representation for each streaming server source. In some embodiments, the streaming data representation of a streaming server source is a data structure that includes a URL of the server source and a specification of a streaming protocol. In some embodiments, the streaming data representation data structure includes additional information about the streaming video, such as a title or caption of the video, a set of metadata related to the video (e.g., location data, actors or presenters appearing in the video, video production personnel, etc.), and a video format in which the video was recorded (e.g., 480i, 480p, 720p, 1080p, etc.). The streaming video system input module 112 also creates a connection representation for connected personal profiles and fundable projects. For example, the streaming video system input module may create a URL to a profile page of a noted authority on a particular project that is currently seeking crowdfunding. In some embodiments, the connection representation for connected personal profiles is a data structure that includes URLs to a set of different profile website pages of profiled persons.

The person profile system input module 114 receives external personal profile information 104, including descriptive text and/or photo metadata and other information pertaining to a person profiled in relation to one or more fundable projects, from a source by way of an input device or API 110b. The person profile system input module 114 then creates a profile data representation of the profiled person, as well as a connection representation (e.g., a URL or hypertext link) for connected streaming videos and fundable projects associated with the profiled person. In some embodiments, the profile data representation of the profiled person is a data structure that stores the received descriptive text and metadata, as well as any received images of the person.

The fundable project system input module 116 receives external fundable project information 106, including descriptive text and/or photo metadata and descriptive audio/video content about the project, from a source by way of an input device or API 110c. The fundable project system input module 116 then creates a project data representation of the fundable project, as well as a connection representation (e.g., a URL or hypertext link) for connected streaming videos and any personal profiles associated with the fundable project. In some embodiments, the project data representation of the fundable project is a data structure that includes the connection representation, the descriptive text and metadata, any images related to the project, and links to any audio/video files about the project.

The payment gateway system input module 118 receives, via an input device or API 110d from a source, external payment gateway information 108, including service provider metadata and authorization-verification credentials. The payment gateway system input module 118 then creates a connected data representation and connection representation (e.g., a URL or hypertext link) for connected fundable projects associated with the payment gateway. For example, the payment gateway may define a set of payment options with service being handled by a set of service providers, such as a virtual currency with payment service provided by a particular virtual currency exchange, a credit card payment option with service provided by a particular credit card processor, etc. In this way, potential donors to a project will be provided with well-defined payment options if they wish to donate to the fundable project.

The set of system storages 120a and 120b receives all data and of the connected data representations for the connected streaming videos, the personal profiles, the fundable projects, and the payment gateways. In some cases, a single storage device includes system storage 120a and system storage 120b. In some other cases, physically separate storage devices are used for system storage 120a and system storage 120b.

The streaming video system access module 122 retrieves the streaming videos and the connection representation for connected personal profiles and fundable projects at the request of an access device or API 130a through which an external user interface 140a (“UI”) and/or application allows a user of the system to view streaming videos (e.g., a graphical user interface “GUI” of a software application with a streaming video player running on a client computing device of a user) related to a particular fundable project. The external UI/application 140a may be any type of software application that allows a user to interface with the crowdfunding system, such as, without limitation, a web browser that connects to a website for the crowdfunding service, a mobile app, a wearable computing device with a mobile app, embedded programs of biometric devices, holographic displays of programs, etc.

The person profile system access module 124 retrieves profile data representations (e.g., text, photo, etc.) and connection representations for connected streaming videos and fundable projects at the request of an access device or API 130b through which the external UI/application 140a allows a user of the system to view profiles of noted authorities and persons profiled in relation to a particular fundable project.

The fundable project system access module 126 retrieves project data representations (e.g., information about a particular fundable project) and connection representations for connected fundable projects at the request of an access device or API 130c through which external UI/application 140b allows a user of the system to view profiles of noted authorities and persons profiled in relation to a particular fundable project.

The payment gateway system access module 128 retrieves connected data representations and connection representations for connected fundable projects at the request of an access device or API 130d through which the external UI/application 140b allows the user payment options for a particular fundable project.

### II. Crowdfunding Process

Some embodiments include a process for providing in-depth contextually relevant project information related to a project seeking crowdfunding. In some embodiments, the process improves the conversion of potential project donors to actual project donors by presenting potential project donors with streaming video conversations, individual personal profiles of conversation participants, related fundable project descriptions, and related donation payment gateways which allows a potential project donor to become informed of the issues being addressed by a particular project seeking crowdfunding. In some embodiments, the process performs separate sets of operations in two phases: a creation phase and a project access phase.

During the creation phase, the process receives input via a user interface which allows a user to define streaming video conversations, individual personal profiles of conversation participants, related fundable project descriptions, and related donation payment gateways. In some embodiments, the process stores the received input in a system storage as a data representation that creates connections between all the related streaming video conversations, individual personal profiles of conversation participants, fundable project descriptions, and donation payment gateways.

During the project access phase, the process retrieves the stored data and transmits the retrieved data for display on a computing display device of a user. The display of the transmitted data in some embodiments shows the connections between related streaming video conversations, individual personal profiles of conversation participants, fundable project descriptions, and donation payment gateways for a particular project.

In some embodiments, the crowdfunding process dynamically creates connections between streaming video conversations by thought leaders to fundable projects related to the issues being discussed in a given video conversation and to the profiles of the thought leaders participating in the video conversations. In some embodiments, the process is performed by a software application that includes a GUI with a set of tools that allows the user to play videos related to a project, view information about the project in general and in depth, and to make donations and selections as needed. Thus, an individual considering a donation to a project is presented with GUI that dynamically navigates the connections between video conversations, thought leader profiles and fundable projects. The presentation of connected video conversations and thought leader profiles increase the probability an individual will donate to a project.

In contrast, other existing crowdfunding methods do not convert as many individuals as is possible from potential project donors to actual project donors. The reason is that the existing crowdfunding methods present individuals with simple lists of available projects for funding without any higher level context of issues being addressed by the projects and without any higher level social endorsement by recognized thought leaders. Many individuals will not donate to a project based on a simple project description without a more compelling social context.

In some embodiments, the crowdfunding process provides a plurality of source and external information about a fundable project, thereby providing individual users of the crowdfunding system with sufficient resources to improve the conversion of these individuals from potential project donors to actual project donors. One such resource is streaming video information about the project. By presenting the individuals with streaming video conversations by thought leaders and/or noted authorities in a field related to the project, each of whom explains details of the issues being addressed by projects, individuals are enabled to make informed crowdfunding decisions. The software application that performs the process of some embodiments includes a web user interface that dynamically connects videos to related fundable projects and thought leader profiles. This connectivity between video conversations, projects and thought leaders will compel more individuals to donate to projects.

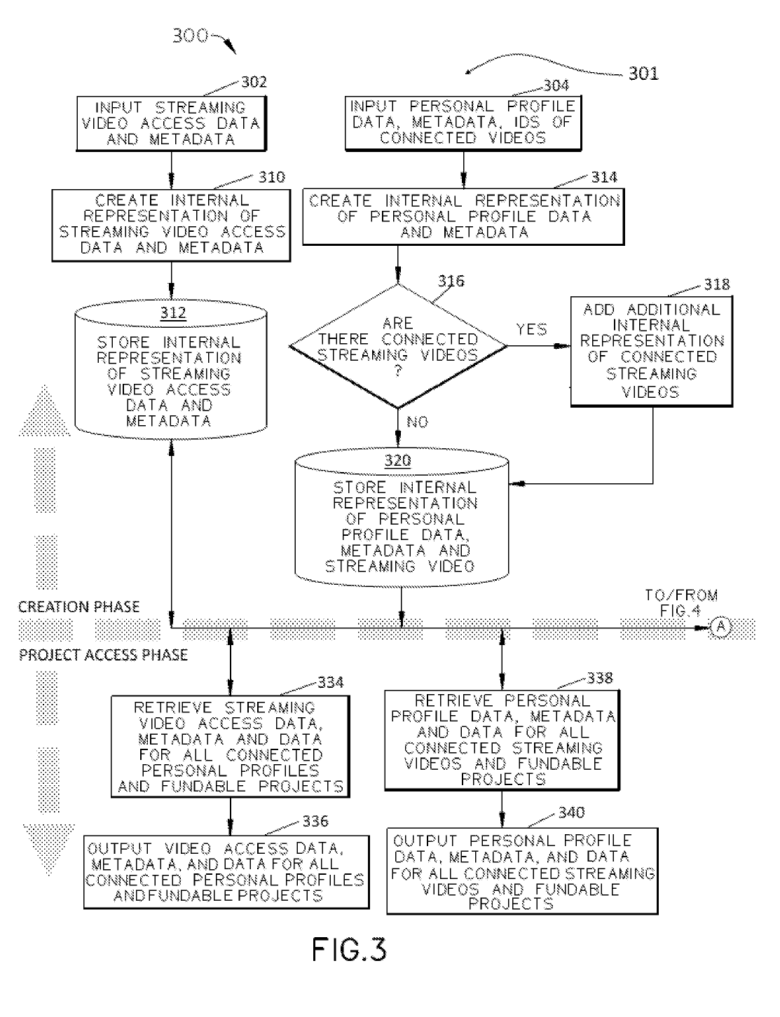

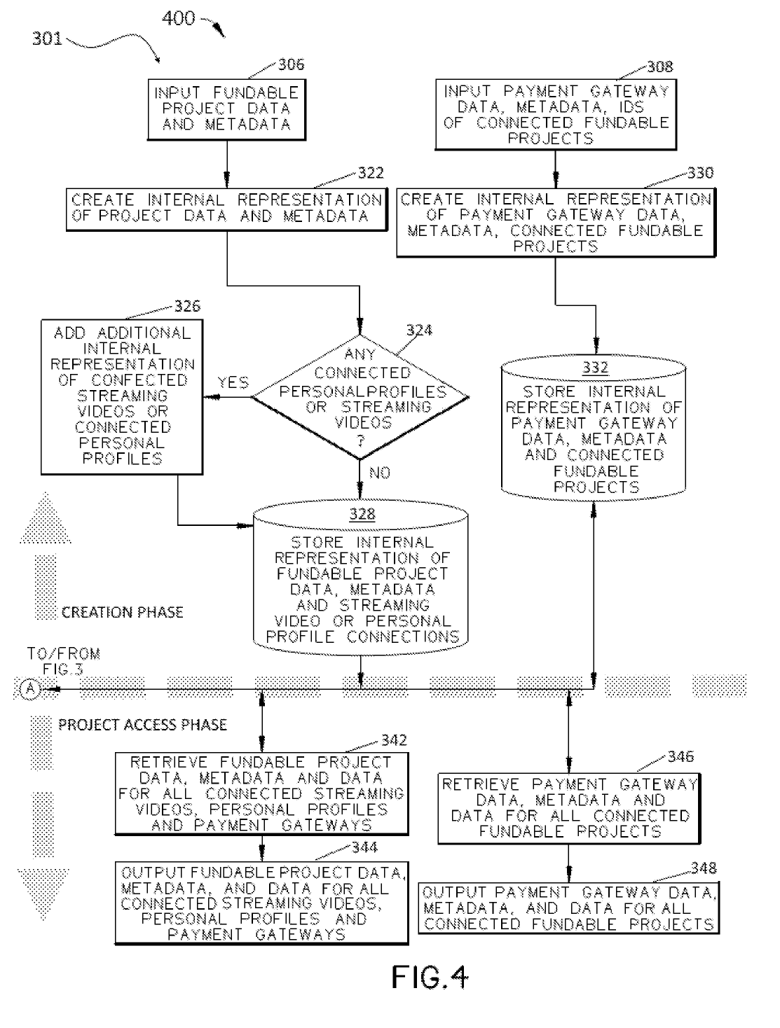

By way of example, FIGS. 3-4 conceptually illustrate flow charts 300 and 400 of a process 301 for creating, providing, and accessing in-depth contextually relevant project information related to a project seeking crowdfunding. In some embodiments, a software application performs the process 301. In some embodiments, a website implements the process 301 when a client software application (e.g., a web browser software application, a mobile app, a desktop custom software application, etc.) access the website. As shown in these figures, the process 301 includes two phases: a creation phase (i.e., the set of operations above the thick dashed dotted horizontal line separating each of FIGS. 3 and 4) in which the process 301 starts at any of four different operations in which data input is received; and a project access phase (i.e., the set of operations below the thick dashed dotted horizontal line) in which the process 301 starts at any of four different operations in which project-related output data is retrieved and transmitted to a client accessing the website of the crowdfunding system 101. The project access phase is discussed later, following discussion of the creation phase of the process 301.

During the creation phase, the process starts at one of receiving streaming video data input (at 302), receiving personal profiles data input (at 304), receiving fundable project data input (at 306), and receiving payment gateway data (at 308). The ensuing operations performed by the process depend on the data receiving operation at which the process begins (i.e, either 302, 304, 306, or 308). The ensuing operations of the process for each data receiving operation are described in numerical order, even though operations can proceed out of numerical order.

When the process 301 receives streaming video data input (at 302), the process then creates (at 310) an internal representation of streaming video access data and metadata. For example, the internal representation may be a data structure with a link to a video file and a set of fields that include information about the video, a protocol for streaming the video, a format of the video, and other such information. Once created, the process 301 stores (at 312) the internal representation of streaming video access data and metadata. For example, the internal representation of streaming video access data and metadata may be stored in the system storage 120a and/or 120b, as described above by reference to FIGS. 1 and 2.

When the process 301 receives personal profiles data input (at 304), the process then creates (at 314) an internal representation of personal profile data and metadata. For example, the internal representation of personal profile data and metadata may be a data structure with information about a person profiled for the fundable project, a set of one or more images of the person, and other such information about the person and the reason for their relation to the project or their association with things related to the project. Next, the process 301 determines (at 316) whether there are any streaming videos connected to the personal profile. If there are not any connected streaming videos, the process 301 transitions to 320, which is described further below. On the other hand, if they are one or more connected streaming videos, the process 301 adds (at 318) an additional internal representation for each connected streaming video. Then the process 301 stores (at 320) the internal representation of personal profile data, metadata, and any connected streaming videos.

When the process 301 receives fundable project data input (at 306), the process then creates (at 322) an internal representation of project data and metadata. For example, the internal representation of project data and metadata may be a data structure with information about the project idea, social causes that are connected to the project, the state of the project, the anticipated completion of the project, and the amount of crowdfunding money being sought for the project. Next, the process 301 determines (at 324) whether there are any personal profiles connected to the fundable project. If there are not any personal profiles connected to the fundable project, the process 301 transitions to 328, which is described further below. On the other hand, if they are personal profiles and/or streaming videos connected to the project, the process 301 adds (at 326) an additional internal representation for each connected streaming video or connected personal profile. Then the process 301 stores (at 328) the internal representation of the fundable project data and metadata, and any internal representations of connected streaming videos and personal profiles.

When the process 301 receives payment gateway data (at 308), the process then creates (at 330) an internal representation of payment gateway data, metadata, and connected fundable projects. For example, the internal representation of payment gateway data, metadata, and connected fundable projects may be a data structure with information about how donations can be made to the fundable project. After the internal representation of payment gateway data is created, the process 301 stores (at 330) the internal representation of the payment gateway data and metadata, as well as the internal representation of the connected fundable project.

Turning to the project access phase, the process 301 starts upon a request to retrieve one of streaming video access data (at 334), personal profile data (at 338), fundable project data (at 342), and payment gateway data (at 346). The ensuing operations performed by the process depend on the data retrieving operation at which the process starts during the project access phase (i.e, 334, 338, 342, or 346). The ensuing operations of the process for each data retrieving operation are described in numerical order, even though operations can proceed out of numerical order.

When the process retrieves streaming video access data (at 334), the streaming video access data representation is retrieved from one or both of the system storage 320 and the system storage 328, as well as any related metadata, and the data of all connected personal profiles and fundable projects. Next, the process 301 outputs (at 336) the video access data, metadata, and data for all connected personal profiles and fundable projects.

When the process retrieves personal profile data (at 338), the personal profile data representation is retrieved from one or both of the system storage 320 and the system storage 328, in addition to any related metadata, and the data of connected streaming videos and fundable projects. Then the process 301 outputs (at 340) the personal profile data, metadata, and data for all connected streaming videos and fundable projects.

When the process retrieves fundable project data (at 342), the internal representation of the fundable project data and metadata is retrieved from one or both of the system storage 328 and the system storage 320, as well as the data of connected streaming videos, personal profiles, and payment gateways. Next, the process 301 outputs (at 344) the fundable project data, metadata, and data for all connected streaming videos, personal profiles, and payment gateways.

When the process retrieves payment gateway data (at 346), the internal representation of the payment gateway data and metadata is retrieved from one or both of the system storage 328 and the system storage 320, in addition to the data of connected fundable projects. Then the process outputs (at 348) the payment gateway data and metadata, and data for all connected fundable projects.

Thus, by using the process 301 described by reference to FIGS. 3 and 4, fundable projects that are seeking crowdfunding can create crowdfunding resources (during the creation phase) which provide invaluable tools and informational resources to potential donors to the project. Similarly, potential donors can access the crowdfunding system through a website and/or software application that allows the user to investigate and research important aspects of a fundable project to which the user may wish to give a donation. Overall, this pushes potential donors on the fence about a project to decide whether to donate or not, thereby improving overall convergence of potential project donors to actual project donors.

In some embodiments, the internal data representation created by the process 301 is an extendable data representation that may include linkages (e.g., URLs or hyperlinks) which connect streaming video of conversions between thought leaders, individual profiles of thought leaders participating in each conversation, fundable projects related to individual video conversations, and fundable projects endorsed by individual thought leaders. Thus, the internal data representation is multi-dimensional in which video conversations, leader profiles, project descriptions, and project donation payment gateway attributes are each a dimension within the internal representation. In some embodiments, each dimension of an internal data representation is capable of connecting to any other dimension. In addition, the internal data representation can be extended for additional dimensions that become defined at some later date after the internal data representation is created. Connections can be made between newly defined dimensions and previously existing dimensions, for each and every internal data representation that is created. In some embodiments, the system automatically extends an internal data representation with additional dimensions related to new thought leader video conversations, individual thought leader profiles, fundable project descriptions and donation interfaces, and/or endorsements of fundable projects by individual thought leaders are added.

### III. User Interface and Website Implementation

In some embodiments, the user interface of the system is intuitive for a potential donor to navigate, allowing him or her to search either the list of streaming video conversations to find a topic of interest, search the profiles of individual thought leaders to find a leader of interest, or search the list of projects to directly find a project of interest. This facilitates the potential donors decision-making process regarding whether or not to donate to a particular fundable project.

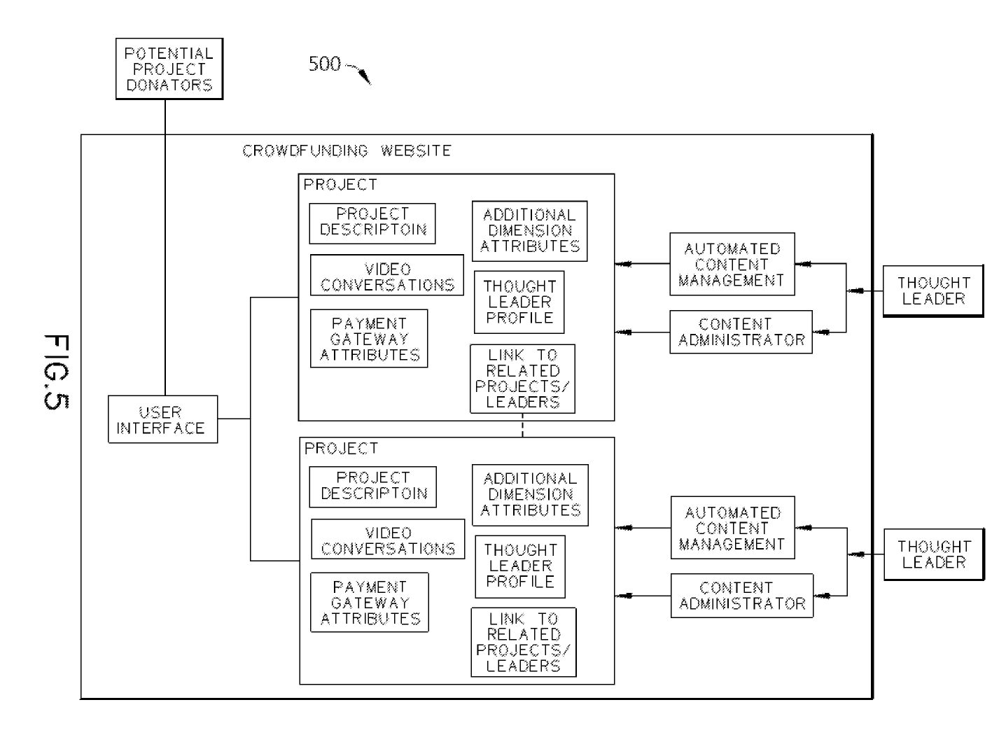

By way of an example, FIG. 5 conceptually illustrates an example of a website 500 that implements the crowdfunding process 301 described above, by reference to FIGS. 3 and 4. In this example website, when a streaming video conversation is first selected through the GUI of the website 500, the potential donor can view and listen to that conversation and then continue their donation decision process by selecting a link to one of the fundable projects connected to that conversation or alternatively can select a link to one of the individual thought leader profiles connected to that conversation. In furtherance of this example, when an individual thought leader profile is first selected through the website by the potential donor, the leader profile may be displayed to allow the potential donor to review details of the thought leader's career, relevance to the fundable project, and other such important thought leader information. Once the potential donor is satisfied with the information retrieved and displayed about the thought leader, the potential donor may then continue making a donation decision, for example, by selecting a link to the list of video conversations that the thought leader has participated in or selecting a link to the list of fundable projects that the thought leader has personally endorsed. Similarly, when a fundable project description is first selected by a user through the GUI of the website, the description will be displayed for the potential donor to review (e.g., can review a summary or can review more detailed project descriptions as needed or desired). The user (potential donor) can then directly make a donation or continue the decision-making process by, for example, selecting a link to an individual profile of a thought leader who endorsed the project or selecting a link to the video conversation which the project is connected with. Thus, the GUI is dynamic and intuitive enough to enable any potential donor user to easily and naturally navigate the connected dimensions of streaming video conversations, thought leader profiles, and fundable projects in an ad hoc fashion that always maintains a navigable view of links to other connected dimensions when viewing the detail of any single specific dimension.

### IV. Donation Interface and Content Management

After a potential donor has completed his or her review of the content materials and information resources related to a particular project, a set of donation tools and fields are displayed in a donation interface. In some embodiments, at least one of the donation tools allows the user (potential donor) to make an instant donation (i.e., an immediate monetary transfer transaction) at the point of navigation. In some embodiments, the donation interface is configured according to which project is currently in scope and uses one or more of the donation payment gateway attributes defined for that project to enable instant donations at the point of navigation. By defining payment gateway attributes for individual projects the crowdfunding system and process allow different project owners to utilize the payment gateway of their choice to process donations as opposed to being forced to use a payment gateway defined by an external party.

In some embodiments, the website GUI includes an administrative content management mechanism and web user interface to allow a content administrator to manually add, edit, or delete video conversations, thought leader profiles, other individual profiles, fundable project descriptions (including the definition of the payment gateway), and to define all the applicable connections between video conversations, thought leader profiles and fundable project descriptions. In some embodiments, the administrative content management mechanism is an automated content management mechanism that allows individual thought leaders or other individuals who have an existing profile to add or endorse new fundable project descriptions via a web user interface where the automated content management mechanism will dynamically create the connections between the fundable project description and the related thought leader profile and video conversation.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. For instance, the process and/or system can be adapted for use in types of crowdfunding not based on individual donations, such as crowdfunded loans and crowdfunded investment in return for equity. Similarly, the process and/or system can be adapted for use in non-financial systems, such as advocacy of a cause, promotion of a product, or other systems where video conversations by recognized leaders or experts can be connected to some cause or product description and the connections between video conversations, leader profiles and the cause or product descriptions is much more compelling to an individual and make it more likely the individual will navigate to the cause or product description then if that individual was browsing a simple list of cause or product descriptions with no connected video conversations or leader profiles. Thus, one of ordinary skill in the art would understand that the invention is not to be limited by the foregoing illustrative details, but rather is to be defined by the appended claims.

### V. Electronic System

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

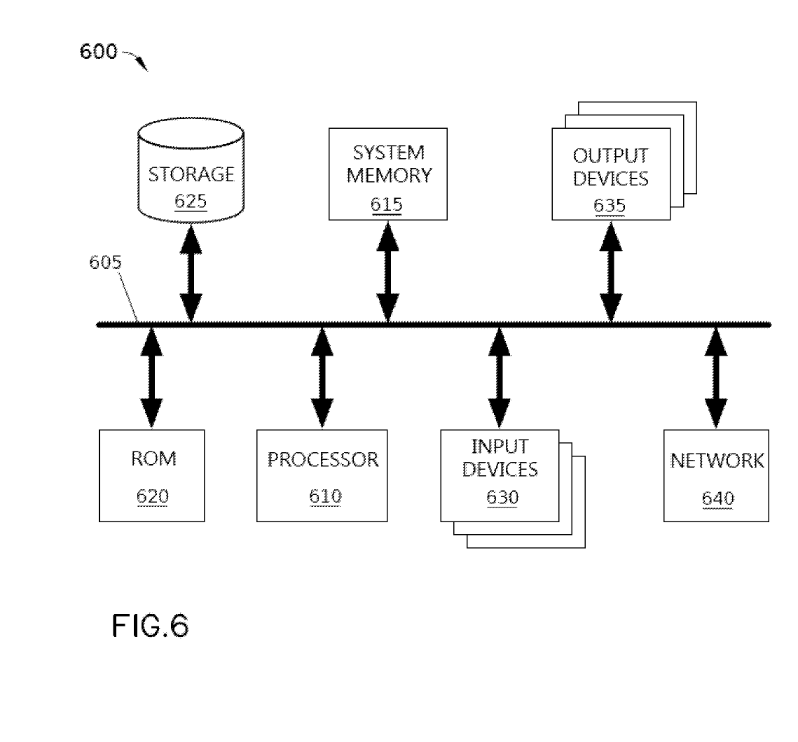

FIG. 6 conceptually illustrates an electronic system 600 with which some embodiments of the invention are implemented. The electronic system 600 may be a computer, phone, PDA, or any other sort of electronic device. Such an electronic system includes various types of computer readable media and interfaces for various other types of computer readable media. Electronic system 600 includes a bus 605, processing unit(s) 610, a system memory 615, a read-only 620, a permanent storage device 625, input devices 630, output devices 635, and a network 640.

The bus 605 collectively represents all system, peripheral, and chipset buses that communicatively connect the numerous internal devices of the electronic system 600. For instance, the bus 605 communicatively connects the processing unit(s) 610 with the read-only 620, the system memory 615, and the permanent storage device 625.

From these various memory units, the processing unit(s) 610 retrieves instructions to execute and data to process in order to execute the processes of the invention. The processing unit(s) may be a single processor or a multi-core processor in different embodiments.

The read-only-memory (ROM) 620 stores static data and instructions that are needed by the processing unit(s) 610 and other modules of the electronic system. The permanent storage device 625, on the other hand, is a read-and-write memory device. This device is a non-volatile memory unit that stores instructions and data even when the electronic system 600 is off. Some embodiments of the invention use a mass-storage device (such as a magnetic or optical disk and its corresponding disk drive) as the permanent storage device 625.

Other embodiments use a removable storage device (such as a floppy disk or a flash drive) as the permanent storage device 625. Like the permanent storage device 625, the system memory 615 is a read-and-write memory device. However, unlike storage device 625, the system memory 615 is a volatile read-and-write memory, such as a random access memory. The system memory 615 stores some of the instructions and data that the processor needs at runtime. In some embodiments, the invention's processes are stored in the system memory 615, the permanent storage device 625, and/or the read-only 620. For example, the various memory units include instructions for processing appearance alterations of displayable characters in accordance with some embodiments. From these various memory units, the processing unit(s) 610 retrieves instructions to execute and data to process in order to execute the processes of some embodiments.

The bus 605 also connects to the input and output devices 630 and 635. The input devices enable the user to communicate information and select commands to the electronic system. The input devices 630 include alphanumeric keyboards and pointing or cursor control devices. The output devices 635 display images generated by the electronic system 600. The output devices 635 include printers and display devices, such as cathode ray tubes (CRT) or liquid crystal displays (LCD). Some embodiments include a touchscreen that functions as both an input and output device.

Finally, as shown in FIG. 6, bus 605 also couples electronic system 600 to a network 640 through a network adapter (not shown). In this manner, the computer can be a part of a network of computers (such as a local area network (“LAN”), a wide area network (“WAN”), or an Intranet), or a network of networks (such as the Internet). Any or all components of electronic system 600 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes and logic flows may be performed by one or more programmable processors and by sets of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIGS. 3-4 conceptually illustrate a process. The specific operations of the process may not be performed in the exact order shown and described. Specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

I claim:

1. A non-transitory computer readable medium storing a program which, when executed by at least one processing unit of a computing device, generates a graphical user interface of a website that enables a potential donor of a project to learn about the project, said program comprising sets of instructions for:
receiving a set of data inputs comprising at least one of a set of video access data input related to a fundable project, a set of personal profile data input related to the fundable project, a set of fundable project descriptive information input that enhances a basic description of the fundable project, and a set of payment gateway input related to making a donation to the fundable project;
creating an internal data representation for each data input in the set of data inputs;
automatically connecting the internal data representation of each data input to the internal data representation of each other data input in the set of data inputs; and
storing each created internal data representation and all connections to internal data representations.

2. The non-transitory computer readable medium of claim 1, wherein the set of data inputs comprises the set of personal profile data input.

3. The non-transitory computer readable medium of claim 2, wherein the program further comprises a set of instructions for determining whether the set of data inputs includes a set of video access data input related to a fundable project.

4. The non-transitory computer readable medium of claim 3, wherein the program further comprises a set of instructions for adding an additional internal representation and connection for the set of video access data input related to the fundable project.

5. The non-transitory computer readable medium of claim 1, wherein the set of data inputs comprises the set of fundable project descriptive information input.

6. The non-transitory computer readable medium of claim 5, wherein the program further comprises a set of instructions for determining whether the set of data inputs includes at least one of a set of video access data input related to a fundable project and a set of personal profile data input.

7. The non-transitory computer readable medium of claim 6, wherein the program further comprises a set of instructions for adding an additional internal representation and connection for any of the set of video access data input and the set of personal profile data input determined to be included.

8. A non-transitory computer readable medium storing a program which, when executed by at least one processing unit of a computing device, accesses a set of resources associated with a fundable project, said program comprising sets of instructions for:
receiving a request to access a particular resource associated with the fundable project;
retrieving the particular resource associated with the fundable project, said particular resource comprising at least one of streaming video access data, personal profile data, fundable project data, and payment gateway data;
transmitting the retrieved particular resource to a client computing device for display on a display device visible to a potential donor of the fundable project.

9. The non-transitory computer readable medium of claim 8, wherein the set of instructions for retrieving the particular resource associated with the fundable project comprises a set of instructions for retrieving data for all connected resources associated with the particular resource.

10. The non-transitory computer readable medium of claim 9, wherein the set of instructions for transmitting the retrieved particular resource comprises a set of instructions for transmitting all connected resources associated with the particular resource.

11. A crowdfunding system that improves convergence of donations to a fundable project by providing a set of information resources associated with the fundable project for a potential donor to view, said system comprising:
a streaming video system input module that creates streaming data representations of streaming videos input by an external computing device;
a personal profile system input module that creates profile data representations of persons input by the external computing device to be profiled in the system;
a fundable project system input module that creates a project data representation for the fundable project; and
a payment gateway system input module that creates a connected data representation for enabling the potential donor to make a donation to the fundable project.
